(19) United States
(12) Patent Application Publication
(10) Pub. No.: US 2007/0133351 A1
(43) Pub. Date: Jun. 14, 2007

(54) Human target acquisition system and method

(76) Inventor: Gordon E. Taylor, Anderson, SC (US)

Correspondence Address: MCNAIR LAW FIRM, P.A., P.O. BOX 10827, GREENVILLE, SC, 29603-0827, US

(21) Appl. No.: 11/299,998

(22) Filed: Dec. 12, 2005

(51) Int. Cl. H04B 1/06

(52) U.S. Cl. 367/118; 367/136

(57) ABSTRACT

The invention is a system for acquiring and mapping the location of a human target within a targeted zone defined by boundaries. The system includes a remote sound detection component, which may be a laser vibrometer, capable of placement at a remote safe distance without physical attachment at the targeted zone which detects sound from within the targeted zone, thereby generating a sound signal accurately representing characteristics of the detected sound. Further, a sound processing computer receives and analyzes the sound signal to determine the location of the sound relative to the targeted zone and generates a location signal representing the location of the sound. A target display is provided for receiving the location signal and outputting an accurate visual representation at the location of the target relative to the boundaries of the targeted zone.

### FIELD OF THE INVENTION

This invention is directed to a system and method for acquiring the location of a target and mapping the location of the target, specifically for use by law enforcement officials in hostage or stand-off situations where the need for acquiring the location of a human target at a distance is present.

### BACKGROUND OF THE INVENTION

The use of sound waves to determine existence of an object behind a barrier has been prevalent for a number of years. These systems are capable of determining the existence of an object, and determining the general location of the object. However, the existing systems fail to accurately map the location of the object from a distance. The existing systems fail in one of two major ways: 1) they require the placement of sound detection devices in close proximity to the target; and, 2) they do not produce an accurate, clear reading of the location of the target within the targeted structure.

There are several systems including those disclosed in U.S. Pat. Nos. 6,466,155 and 6,307,475, for determining the location of a target inside a targeted structure that use microwaves and other sound detection devices that are placed in close proximity to the targeted structure. While these can produce a location of a target inside the targeted structure they are insufficient for use by law enforcement officials to locate a human target in hostage situations or standoff situations. The necessity of having these sound detection devices close to the building structure requires the law enforcement official to place their life in jeopardy in attempting to place the sound detection device in close proximity to the structure.

The second manner in which the prior systems fail for the purposes of law enforcement are that they do not produce an accurate mapping of the location of the sound signal. While radar, sonar and other forms of sound detection including ultrasound can be used to determine a general location, they are unable to specifically locate a target within a targeted structure. Further, even if a system capable of precise determination of where the sound signal is located within a building did exist, a reliable mapping system would still be needed to accurately map the exact location of the sound signal in the structure.

Laser vibrometers have the capability of accurately detecting sound from a distance, and through barriers. Laser vibrometers are currently used in the automotive industry, specifically by Formula One and Nascar engine manufacturers to improve the valve performance of engines. The vibrometers are capable of accurately determining the sounds that take place from within an engine while operating and generating a sound signal representing the sounds detected by the vibrometer. Further, these vibrometers have been used to test golf club heads, flat panel loudspeakers, and other products to determine characteristics of these products. Laser vibrometers have not been used to determine the location of human targets in targeted zones, and no computer system for processing information from a laser vibrometer and mapping location of a human target within a targeted zone has been produced.

Accordingly, an object of the present invention is to provide a system that uses sound detection devices which can be placed at a safe distance from a targeted structure to determine location of a target inside of the targeted location.

Another object of the present invention is to accurately and automatically map the location of a target, particularly a human target, within a targeted structure based on sound information obtained by the sound detection devices.

### SUMMARY OF THE INVENTION

The above objectives are accomplished by providing a system for acquiring and mapping the location of a human target within a targeted zone defined by boundaries. The system includes a remote sound detection component, which may be a laser vibrometer, capable of placement at a remote safe distance without physical attachment at the targeted zone which detects sound from within the targeted zone, thereby generating a sound signal accurately representing characteristics of the detected sound. Further, a sound processing computer in communication with the sound detection component receives and analyzes the sound signal to determine the location of the sound relative to the boundaries of the targeted zone and generates a location signal representing the location of the sound. A target display is provided in communication with the sound processing computer. The display receives the location signal and outputs an accurate visual representation at the location of the target relative to the boundaries of the targeted zone. Both the sound processing computer and the target display may be embodied in a portable computer for mobile use by users at remote locations for accurately mapping the location of a human target within the targeted zone.

An input component may be included to receive input from a user representing the interior boundaries of the targeted zone. The boundaries define an interior layout of room spaces of the targeted zone.

The sound detection component may emit a continuous sound detection beam to contact an exterior wall of the targeted zone, thereby detecting vibrations on the exterior wall of the targeted zone indicating a sound within the targeted zone. Further, the sound detection component generates a sound signal, accurately representing characteristics of the detected sound, when the sound detection beam detects vibrations on the exterior wall of the targeted zone. A video card may be embodied within the computer readable medium to generate a location signal representing an outputable visual representation of the detected sound.

In a further embodiment, the invention is directed to a computer readable medium in communication with a sound detection device. A set of computer readable instructions is in communication with the computer readable medium. The set of instructions includes receiving instructions for receiving the sound signal from the sound detection device; analyzing instructions for analyzing the sound signal to determine a location of the detected sound relative to the boundaries; mapping instructions for mapping the location of the detected sound on a visual representation of the zone are included in the zone boundaries, and display instructions for visually displaying the exact location of the human target in the zone with respect to the boundaries on an associated visual display. Thus, the location of the human target may be accurately determined within the targeted zone for further action by law enforcement personnel. The analyzing instructions further include instructions for determining the loudness, time of arrival, shape and reverberation characteristics of the sound signal for accurately determining the location of the sound signal. The set of computer readable instructions further comprise noise canceling instructions for canceling any background noise before mapping the location of a signal. The set of canceling instructions include instructions for determining the origin of the sound signal received and canceling any signal not received from the desired origin before analyzing the signal. The computer readable medium may be embodied in a pen-enabled portable computer for mobile use by law enforcement at remote locations for accurately mapping the location of a human target within a targeted zone. The input received from a user via the pen-enabled portable computer, can represent external interior boundaries of the targeted zone defining the interior layout of the targeted zone.

In a further embodiment, the method for acquiring the location of a target within a targeted zone is provided. The method comprises the steps of providing a sound detection device in communication with a computer readable medium at a distance from the targeted zone, wherein input is received into the computer readable medium representing a targeted zone including the exterior boundaries of the targeted zone, A signal is received which represents the characteristics of a detected sound from the sound detection device by the computer readable medium, analyzes the signal by the computer readable medium to accurately determine the location of the detected sound based on the characteristics of the sound signal and maps the determined location of the sound relative to the exterior boundaries of the targeted zone. The location of the sound is displayed on an associated visual display depicting the graphical representation of the targeted zone.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a schematic illustration of a system and method for determining the exact location of a human target within a building according to the invention;

FIG. 2 is a schematic illustration further illustrating the system and method for determining the exact location of a human target within a building using sound detection devices and an associated computer;

FIG. 3A is a perspective view illustrating a display screen on a computer that is used according to the invention having a floor plan inputted on the display screen and the target location mapped on the floor plan;

FIG. 3B is a block diagram illustrating the components of a computer system used in the system and method according to the invention;

FIG. 4 is a flowchart illustrating the operation of a system and method for determining the exact location of a human target within a targeted zone according to the invention.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated by a set of computer readable instructions embodied in a computer readable medium that is designed to perform a specific task or tasks. Actual computer or executable code or computer readable code may be contained within one file or one storage medium but may also span several computers or storage mediums.

The present invention is described below with reference to flowchart illustrations of methods, apparatus (“systems”) and computer program products according to the invention. It will be understood that each block, or step of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

The computer program and readable instructions may be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions.

The term media is used to include audio, video, animation or any other form audio or visual information. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

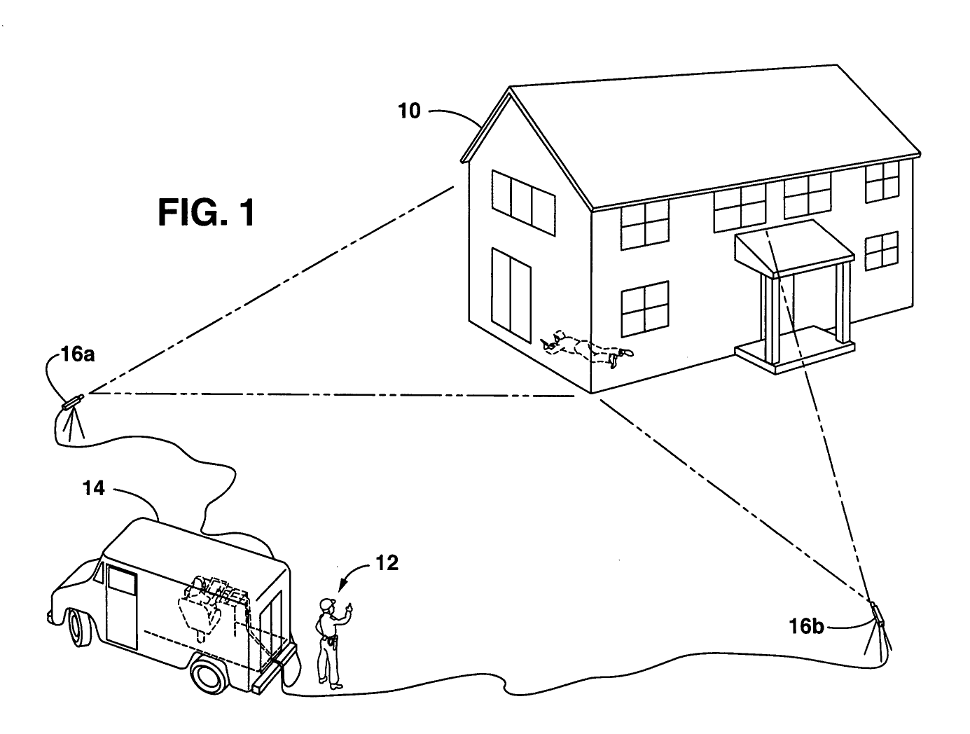

Referring now to FIG. 1, a target acquisition and mapping system, designated generally as A, is illustrated for accurately mapping a human target “T” enclosed within a residential dwelling 10. Law enforcement personnel 12 outside of the dwelling have set up target system A to identify the location of target T in the dwelling. In this case, law enforcement may be trying to simply locate the person so that law enforcement can enter the dwelling to capture the person, or the person may be targeted for a firearm. A sound processing computer C enclosed in a police van 14 is provided according to the invention which communicates with sound detection components. The components illustrated are two laser vibrometers 16a and 16b located at a safe distance from the dwelling. The laser vibrometers may be placed in their operational positions without the need of having personnel get within firing range of the house. The laser vibrometers are connected by wiring to the sound processing computer C set up inside the police van. Sound processing computer C processes the sound signal to accurately locate target T. Once located, the location of target T is mapped and visually displayed on display 40. Note that a police van or other mobile unit may or may not be used in this invention. The sound processing computer C that connects to the sound detection component is in a preferred embodiment hand-held and easily transportable without the need of a police van.

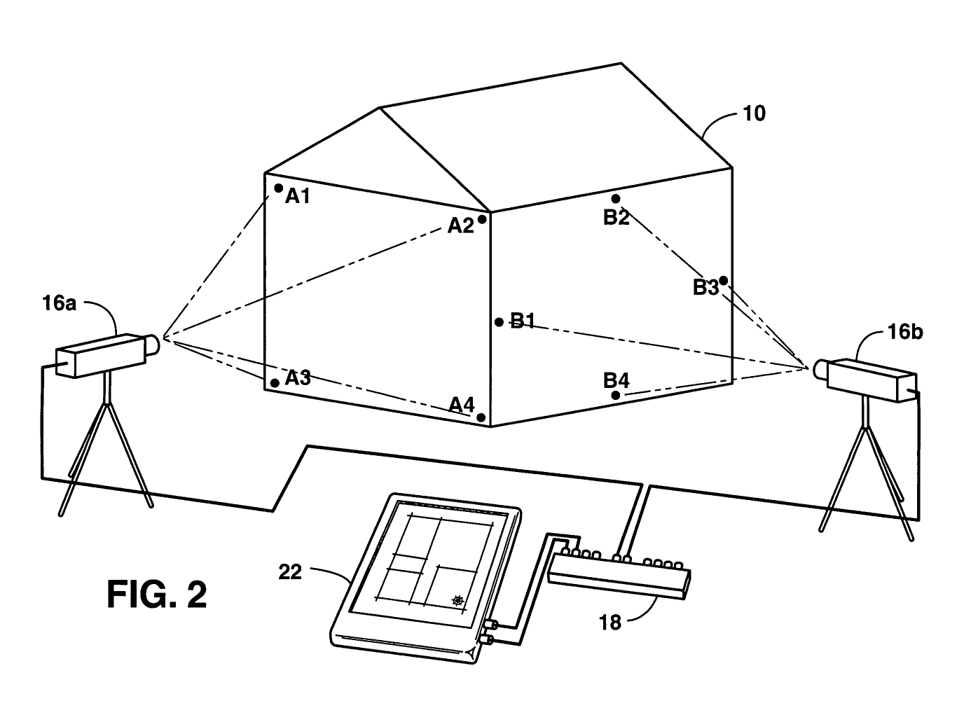

Referring now to FIG. 2, a more detailed illustration of the invention is shown wherein the sound surveillance of target T in the dwelling 10 is illustrated with regard to the focusing points of the laser vibrometers 16a and 16b and the processing of signals received by the vibrometers in the processing system of the present invention. As noted above, the laser vibrometers are located a safe distance from the housing. This is one of the advantages that has been realized according to the invention with the use of sound detecting devices that may be located safe distances from the house. In particular, the laser vibrometers have been found advantageous because of ability to detect minute vibrations, remotely, non-invasively, at large distances. Further, there is no need to have a physical device placed on the structure (window, door, etc.) and the vibrometers have the ability to scan over large areas.

In the illustrated embodiment, the laser vibrometers are multi-point vibrometers wherein each vibrometer uses four points (beams). A suitable vibrometer is the Polytec PSV 400 sold by Polytec. Each point of the laser beam is directed on each window of the house to detect human activity behind each window.

These laser vibrometers can be spaced at least a hundred feet from the house so that personnel can easily install these vibrometers in a safe manner. The sound signals received by the laser vibrometers may be transmitted to an audio interface that allows the sound to be transmitted to multiple locations. Alternatively, the signals may be transmitted directly to sound processing computer C. In a preferred embodiment a fire wire 8 channel audio interface will be used to allow multiple computers to be connected in a very efficient, accurate manner. Note that m-audio produces a fire wire recording interface 18 that would work very well with the invention as disclosed. The signals are received by the interface which inputs the signals to the sound processing computer which is illustrated in the form of a pen enabled personal computer 22. Other computer systems may also be utilized but the pen enabled personal computer is particularly advantageous in this application for the reasons that the floor plan of the building, i.e. boundaries, may be input on the scene according to a surveillance of the dwelling and an approximation of the floor plan, or downloading of the floor plan of local government records, or just a rough drawing of the perimeter of the floor plan. A law enforcement official familiar with the general layout of the house in question may sketch out a rough draft of the perimeter of the house with some interior walls and doors shown. Alternatively, a more detailed floor plan could be available that could be sketched in by the law enforcement official more accurately. In the best possible scenario, floor plans of homes may be available on-line through builders' websites or tax records and these could be downloaded to the pen-enabled PC and appear on the screen and more accurately map the location of any sounds occurring in the targeted structure.

Sound detection devices 16a and 16b are shown at the bottom of the figure targeting a target location. The sound detection devices shown in the figure are preferably multipoint laser vibrometers. Note that in alternative embodiments high sensitivity microphones or a variety of other types of sound detection devices could be used to obtain sound signals from a targeted structure. The multipoint vibrometers are targeting as many as four points on different sides of the targeted structure represented as A1, A2, A3, A4, B1, B2, B3 and B4. The four points may correspond to windows to measure the vibrations of each window separately. The vibrometers emit a sound detection beam that contacts the structure. This beam detects any vibrations in the structure that represent sounds within the structure.

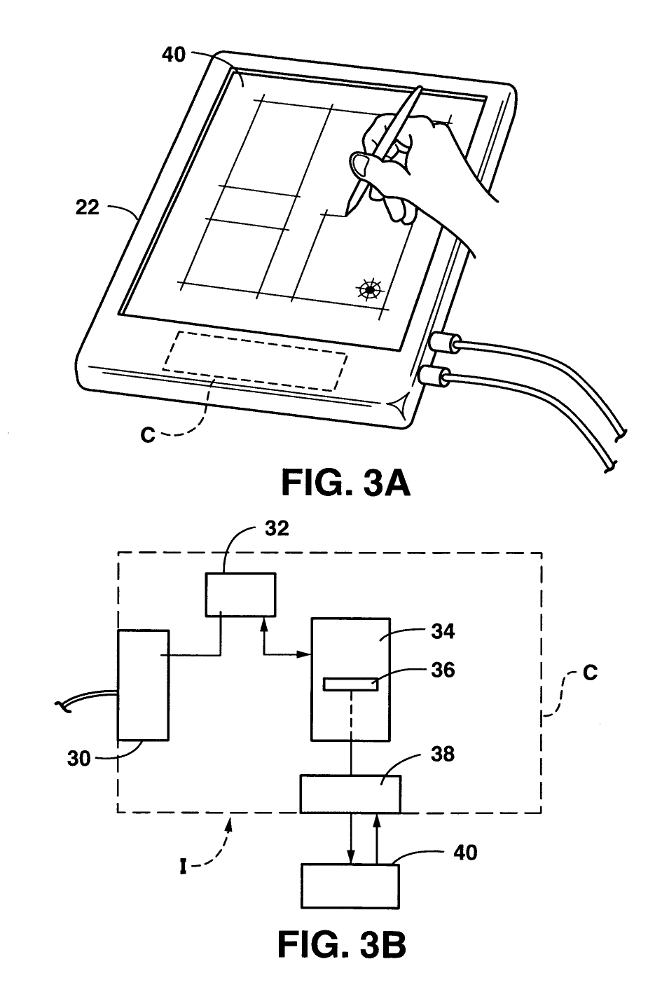

Note that in alternative embodiments the sound detection devices could communicate via wireless communications or any other feasible means of communication with either the audio interface or directly to the associated computer without the interface. In this environment an eight channel audio interface is used which would allow multiple users and multiple computers to be linked to the same sound detection devices. A pen enabled PC is used in the preferred embodiment as it allows the user of the system to sketch a diagram of the floor plan of the targeted location. The targeted location floor plan is shown more fully in FIG. 3A.

FIG. 3A shows the display screen 40 of the associated computer 22 with the system with a floor plan drawn on it. In a pen enabled PC the user of the system could input a rough sketch of the floor plan on to the system and then any mapping of the location would take place on the floor plan that has been inputted by the user. Please note that a pen enabled PC is not the only embodiment that this could take place in rather any type of associated computer could be used that receives input of a floor plan through various means. One potential means would be receiving a floor plan via scanning means or having it transmitted via electronic communications such as email or a file transfer protocol system. Once the floor plan sketch or actual floor plan has been inputted on to the computer it will be displayed on the screen. As can be seen from the figure, the sound signal that would have been mapped normally within a rectangular shape can now be mapped directly within a predetermined room within the targeted structure. Note that in this example the target T2 is shown in the lower right hand area of the house in what appears to be a side room that law enforcement will have to go in through a long main hallway to apprehend the target. Note that this information will be extremely valuable to law enforcement officials as they will determine the safest path to apprehending the target. This additional functionality is very useful to law enforcement officials in that they can determine what room and what barriers may exist between them and the potential target.

Referring now to FIG. 3B, the sound signal received by the tablet is processed according to the computer board C. Sound card 30 receives sound signals from the sound detection component either directly or through the audio interface. Processor 32 controls the operation of the sound card and the operation of memory 34 and specifically the mapping program 36 that resides in memory 34. The mapping program 36 runs on processor 32 and analyzes any sound signals that come in through sound card 30 to determine the location of the target within the targeted structure.

Once the program 36 has mapped the location of the target it displays the output to display 40 through video card 38. Note that display 40 in the situation of a pen enabled PC is also capable of receiving input as well as displaying output. It can receive input through the use of the pen or stylus to draw a floor plan of the associated structure and display the floor plan via video card 38.

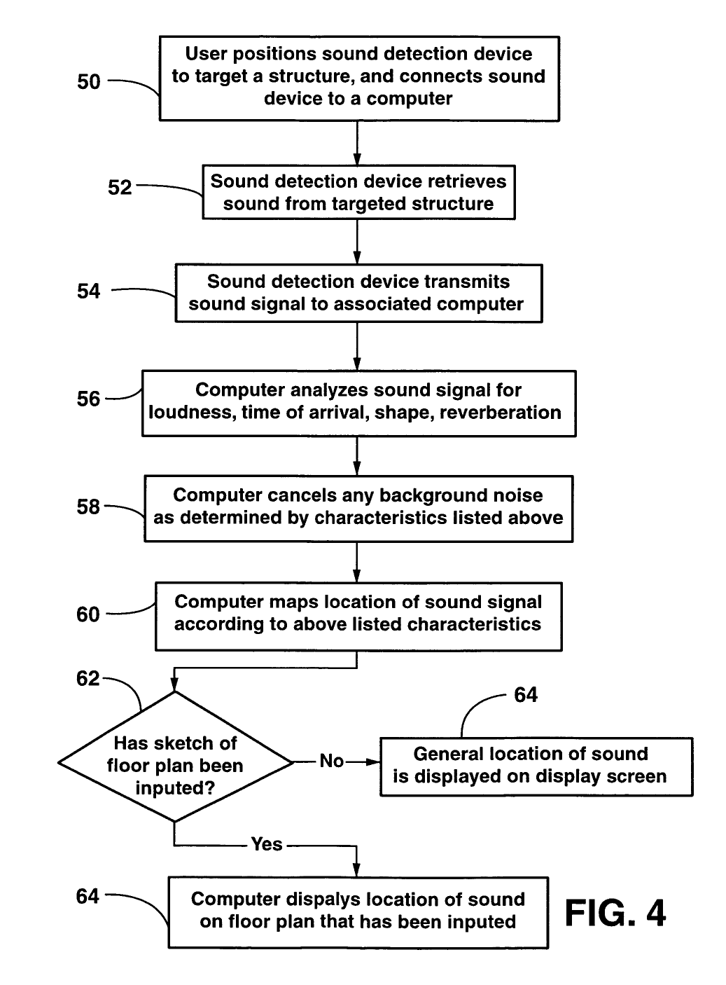

Referring now to FIG. 4, operation of the system and method according to the invention will be described using a hostage situation as an example. In this case, the user, law enforcement personnel positions the sound detection devices at a safer, but effective, distance from the structure and begin targeting the structure with the sound device and connect the sound device to an associated computer at step 50. At any point during the following steps the user may input a sketch of the floor plan of the building being targeted. This input can be done on a pen enabled PC via a rough sketch, it can be accomplished via scanning in a floor plan of the house or any other reasonable means for inputting a floor plan of the target into the computer. Once the sound detection device has been properly positioned and connected, the sound detection device will begin to retrieve sound from the targeted structure at step 52. Once the sound detection device begins retrieving sound signals, it will then transmit those sound signals to the connected computer at step 54. Once the computer has received those sound signals, the computer analyzes those sound signals for information related to the loudness of the sound, the time of arrival of the sound, the shape of the sound wave and any reverberation of the sound.

For instance, if an “event” (e.g. speech, noise made by person inside) is detected by all vibrometers, it could be analyzed in two steps. First, the system will find the earliest arrival time. Based on this, it would then indicate likelihood of person being at that location. Second, the system would find the maximum amplitude of the sound wave. This determination is used to corroborate the likelihood of a person being near that location.

Once the computer has analyzed these factors, it determines what sounds are actually coming from within the house and what sounds are merely background noise. Once the background noise has been identified it is cancelled out from the sound signals being used to map location at step 58. Upon canceling the background noise, the computer is able to map the location of the sound signal according to the above listed characteristics at step 60. Please note that the above listed characteristics are merely one way of analyzing the location of the sound signal and filtering any background noises not associated with that sound. There are several methods to determine location of sound based on the properties of the sound signal. In alternative embodiments, these alternative methods of determining location could be used. For example, Doppler technology has advanced to the point where locating sound is accomplished by determining Doppler characteristics of the sound signal. Using the Doppler characteristics may be more effective in alternative embodiments in mapping the location of a sound behind a barrier. Further, any analysis of sound location based on sound signal characteristics could be used in this invention in alternative embodiments. The analysis of the shape of the sound wave, the reverberation of the sound, the time of arrival of the sound, and the loudness of the sound does not preclude one from using any alternative method of sound mapping based on any other sound characteristics. At this point, if a sketch of the floor plan has been inputted at any point during this process the computer will determine that that sketch was inputted at step 62 and then display the location of the sound signal on the floor plan that has been inputted at step 64. If the set of computer readable instructions determines at step 62 that no floor plan has been inputted then the system will display a general location of the sound signal on the display screen at step 64.

While a preferred embodiment of the invention has been described using specific terms, such description is for illustrative purposes only, and is to be understood that changes and variations may be made without departing from the scope or spirit of the following claims.

What is claimed is:

1. A system for acquiring and mapping the location of a human target within a targeted zone defined by boundaries comprising:
a remote sound detection component capable of placement at a remote safe distance without physical attachment at said targeted zone for detecting sound from within the targeted zone and generating a sound signal accurately representing characteristics of the detected sound;
a sound processing computer in communication with said sound detection component for receiving the sound signal and analyzing the sound signal to determine the location of the sound relative to the boundaries of the targeted zone and generating a location signal representing the location of the sound; and
a target display in communication with said sound processing computer for receiving said location signal and outputting an accurate visual representation at the location of the target relative to the boundaries of the targeted zone.

2. The system of claim 1 further comprising an input component for receiving input from a user representing the interior boundaries of said targeted zone defining an interior layout of room spaces of the targeted zone.

3. The system of claim 1 wherein said sound detection component comprises a laser vibrometer for placement at a distance from the targeted zone and accurately detecting sound within the targeted zone and generating a sound signal representing characteristics of the detected sound.

4. The system of claim 1 wherein said sound processing computer and said target display are embodied in a portable computer for mobile use by users at remote locations for accurately mapping the location of a human target within a targeted zone.

5. The system of claim 1 wherein said sound detection component emits a continuous sound detection beam to contact an exterior wall of said targeted zone for detecting vibrations on the exterior wall of the targeted zone indicating a sound within said targeted zone.

6. The system of claim 5 wherein said sound detection component generates a sound signal when said sound detection beam detects vibrations on the exterior wall of the targeted zone, said sound signal accurately representing characteristics of the detected sound.

7. The system of claim 1 further comprising a video card embodied within said computer readable medium for generating a location signal representing an outputable visual representation of the detected sound.

8. A system for acquiring and accurately mapping the location of a human target within a targeted zone defined by boundaries comprising:
a sound detection device capable of detecting sound, including sound from a human target, at a remote distance without physical attachment at the targeted zone and generating a sound signal accurately representing the characteristics of the detected sound;
a computer readable medium in communication with said sound detection device;
a set of computer readable instructions in communication with said computer readable medium comprising:
receiving instructions for receiving said sound signal from said sound detection device;
analyzing instructions for analyzing the sound signal to determine a location of the detected sound relative to the boundaries;
mapping instructions for mapping the location of the detected sound on a visual representation of the zone including the zone boundaries; and
displaying instructions for visually displaying the exact location of the human target in the zone with respect to said boundaries on an associated visual display;
whereby the location of the human target may be accurately determined within the targeted zone for further action by law enforcement personnel.

9. The system of claim 8 wherein said set of computer readable instructions further comprise input instructions for receiving input from a user representing interior boundaries of the targeted zone defining an interior layout at the targeted zone.

10. The system of claim 8 wherein said analyzing instructions include instructions for determining the loudness, time of arrival, shape and reverberation characteristics of the sound signal for accurately determining the location of the sound signal.

11. The system of claim 8 wherein said set of computer readable instructions further comprise noise canceling instructions for canceling any background noise before mapping the location of a signal.

12. The system of claim 11 wherein said set of canceling instructions include instructions for determining the origin of the sound signal received and canceling any signal not received from the desired origin before analyzing the signal.

13. The system of claim 8 wherein said sound detection device comprises a laser vibrometer adapted for placement at a generally safe distance from the targeted zone for detecting sound within the targeted zone and generating a sound signal representing characteristics of the detected sound.

14. The system of claim 8 wherein said computer readable medium is embodied in a pen-enabled portable computer for mobile use by law enforcement at remote locations for accurately mapping the location of a human target within a targeted zone.

15. The system of claim 14 wherein said set of computer readable instructions further comprise input instructions for receiving input from a user via said pen-enabled portable computer, said input representing external interior boundaries of the targeted zone defining the interior layout of the targeted zone.

16. A method for acquiring the location of a target within a targeted zone comprising the steps of:
providing a sound detection device in communication with a computer readable medium at a distance from the targeted zone;
receiving input into the computer readable medium representing a targeted zone including the exterior boundaries of the targeted zone;
receiving a signal representing the characteristics of a detected sound from the sound detection device by the computer readable medium;
analyzing the signal by the computer readable medium to accurately determine the location of the detected sound based on the characteristics of the sound signal;
mapping the determined location of the sound relative to the exterior boundaries of the targeted zone; and,
displaying the location of the sound on a graphical representation of the targeted zone on an associated visual display.

17. The method of claim 16 further comprising the step of receiving input from a user representing exterior boundaries of a targeted zone defining the targeted zone.

18. The method of claim 17 wherein said targeted zone is a structure and said input from user represents exterior and interior boundaries defining an interior layout of the targeted structure.

19. The method of claim 16 further comprising the step of canceling any background noise prior to analyzing the location of the sound.
